(19) United States
(12) Patent Application Publication
(10) Pub. No.: US 2021/0339905 A1
(43) Pub. Date: Nov. 4, 2021

(54) FOLDABLE STORAGE CONTAINER

(71) Applicant: Mark Obeng Kofi Darkwah, Dallas, GA (US)

(72) Inventor: Mark Obeng Kofi Darkwah, Dallas, GA (US)

(21) Appl. No.: 16/866,192

(22) Filed: May 4, 2020

(51) Int. Cl. B65D 21/08; E05B 47/00; E05B 65/52

(52) U.S. Cl. CPC B65D 21/086; E05B 65/52; E05B 47/0001

(57) ABSTRACT

A foldable storage container is implemented which is configured with a lockable door that can be accessed with a key code. The door of the container includes a deadbolt which engages with a receptacle on the frame of the container, which unlocks responsive to receiving a correct key code. In addition, hinges are placed on all four sides of the rear panel and the front panel to enable folding of the container. The top and bottom sets of panels advance upwardly and downwardly, respectively, and the left and right sets of panels push inward into the container's cavity. This compresses the container so that it can be carried and transported more easily, such as through doorways. The foldablility of the container enables the container to accept larger-sized packages while still being dynamically adaptable to fit in doorways to, for example, bring the foldable storage container indoors after use.

### BACKGROUND

As e-commerce becomes even more prevalent in society, packages and other deliveries, such as drugs and food, are being left unattended at the door and thereby causing an increase in thievery.

### SUMMARY

A foldable storage container is implemented which is configured with a lockable door that can be accessed with a key code. The door of the container includes a deadbolt which engages with a receptacle on the frame of the container, which unlocks responsive to receiving a correct key code. In addition, hinges are placed on all four sides of the rear panel and the front panel to enable folding of the container. The top and bottom sets of panels advance upwardly and downwardly, respectively, and the left and right sets of panels push inward into the container's cavity. This compresses the container so that it can be carried and transported more easily, such as through doorways. The foldablility of the container enables the container to accept larger-sized packages while still being dynamically adaptable to fit in doorways to, for example, bring the foldable storage container indoors after use.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative representation of the foldable storage container in an opened position;

FIG. 2 shows an illustrative representation of the inside of the foldable storage container;

FIG. 3 shows an illustrative representation of the foldable storage container utilizing a strap;

FIG. 4 shows an illustrative representation of the foldable storage container from the rear;

FIG. 5-7 show illustrative representations of the foldable storage container in a folded position from various angles; and

FIG. 8 show an illustrative representation of a hanging bracket which may be used with the foldable container.

Like reference numerals indicate like elements in the drawings. Elements are not drawn to scale unless otherwise indicated.

### DETAILED DESCRIPTION

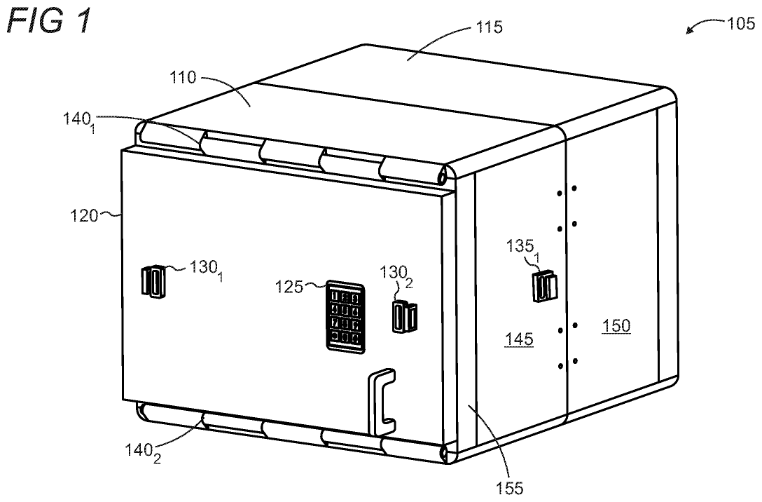

FIG. 1 shows an illustrative representation of a foldable storage container 105 which is configured control access to the container's inside cavity using a lock and which is also foldable to provide easier handling and transportation. The container includes a front door 120 which includes a keypad 125 which controls deadbolt that engages and disengages from a receptacle on the container's frame 155. While a numerical keypad is shown, other locks are also possible, such as padlocks, key locks, alpha-numeric keypad locks, etc. Thus, the keypad may be referred to herein as an input mechanism to encapsulate the various types of locks.

The keypad 125 may be set to open the container's door 120 by disengaging the deadbolt from the frame 155 responsive to receiving a correct numerical key code. An actuator may be utilized inside the door which connects the bolt to a motor that extends and contracts the bolt. The actuator may be triggered by, for example, input of the correct access code at the keypad or other input mechanism depending on the implementation. The actuator may be in communication with a processor, or controller, at the keypad which verifies input of the correct access code and then triggers operation of the actuator and motor to revert the bolt from the frame. Other forms and designs of lock implementations are also possible and the present disclosure is not limited to any particular lock design.

The foldable storage container 105 includes a set of front top and bottom hinges 140 to enable the container to fold. These hinges are attached to the front frame 155 of the container and the front top panel 110 and the front bottom panel (not shown). In typical implementations, the top and bottom are symmetrical and the left and right sides are symmetrical, so discussion of one side, such as the top panels, correlates to discussion to the bottom panels.

The foldable storage container 105 includes the front and rear right side panels 145, 150, which are also connected to a set of hinges (not shown) shown that will be described in greater detail below. The door 120 includes front strap mounts 130 to help secure the container together when folded. The front right panel 145 includes a right side strap mount 135 which receives one end of the strap, and the other end may secure to, for example, front strap mount 130 positioned near the keypad 125.

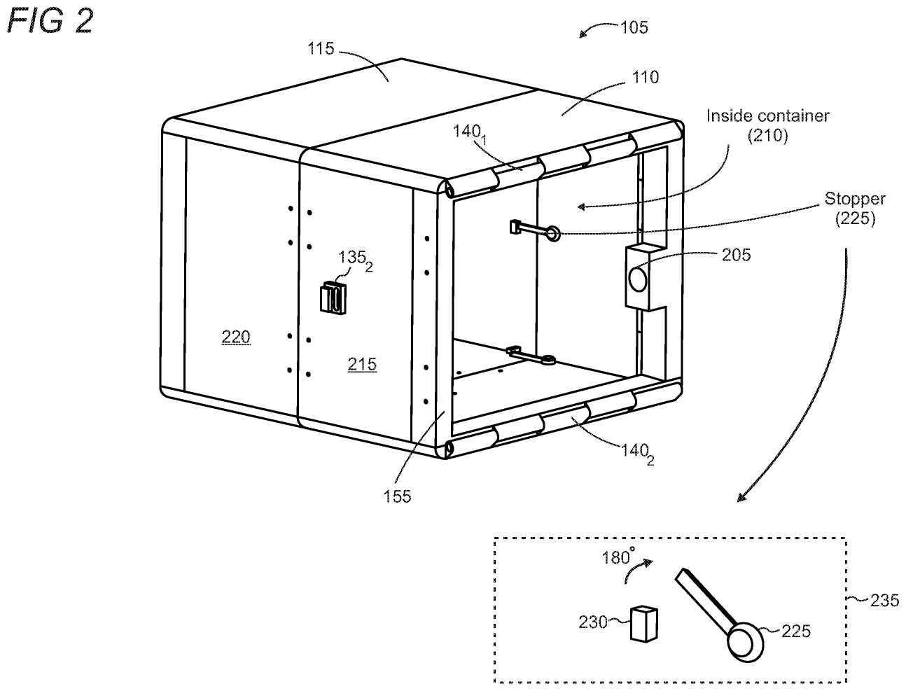

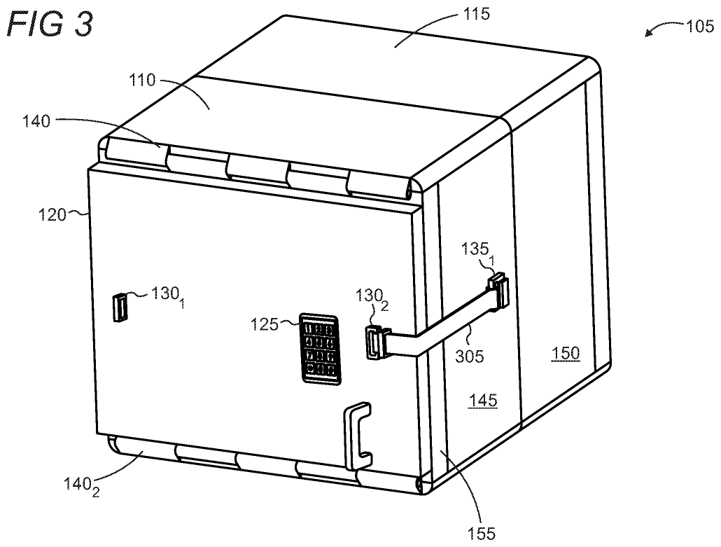

FIG. 2 shows an illustrative representation in which the foldable storage container 105 includes a front left side panel 215 and a rear left side panel 220. The front left side panel 215 includes a left side mount 135 similar to the right side strap mount 135 discussed above (FIG. 1), but engages with the front strap mount 130 on the left side of the door. FIG. 3 shows an illustrative representation of a strap 305 extending between the right side strap mount 135 and the front strap mount 130. The strap mounts may operate like a buckle in which the strap weaves through the respective buckles and can be loosened or tightened accordingly.

In FIG. 2, the front door has been removed for clarity in exposition. For example, the inside of the container 210 and the front panel hinges 140 are more clearly depicted. The receptacle 205 on the frame 155 of the container is also depicted, in which the receptacle may receive the deadbolt on the door when the lock is engaged.

The inside of the container includes stoppers 225 between each front and rear side panel. The stoppers prevent the container from folding when in use. When the user wishes to fold the container for storage or transportation, the user can disengage the stopper from its latch 230 by rotating the hook/stopper 180°, as representatively shown by numeral 235. Once the stoppers are disengaged, the user can push the side panels inward or the top and bottom panels outward to begin collapsing the container.

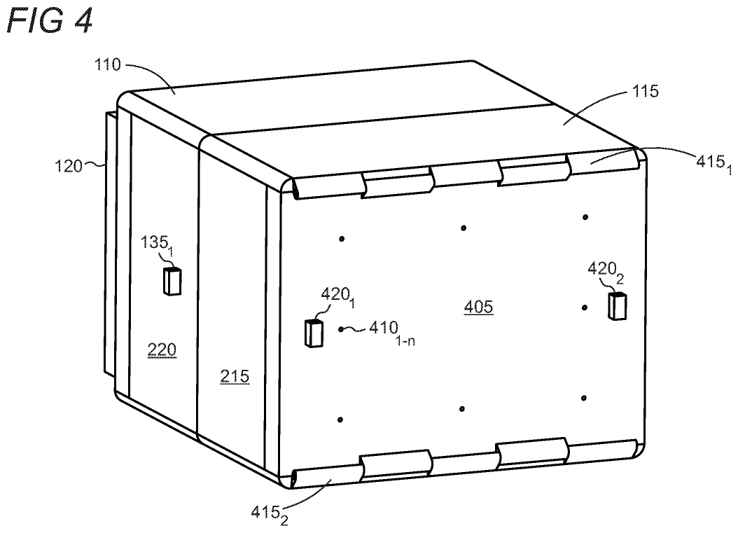

FIG. 4 shows an illustrative representation in which a rear panel 405 of the foldable storage container 105 also includes top and bottom hinges 415 for collapsing the container. Like the door 120 in the front of the container, the rear panel also includes rear strap mounts 420 for receiving a strap to secure the container in a folded state. Furthermore, the rear panel includes holes 410 which can be used, in some implementations, to secure the container to a hanger for hanging on a door, such as the front door.

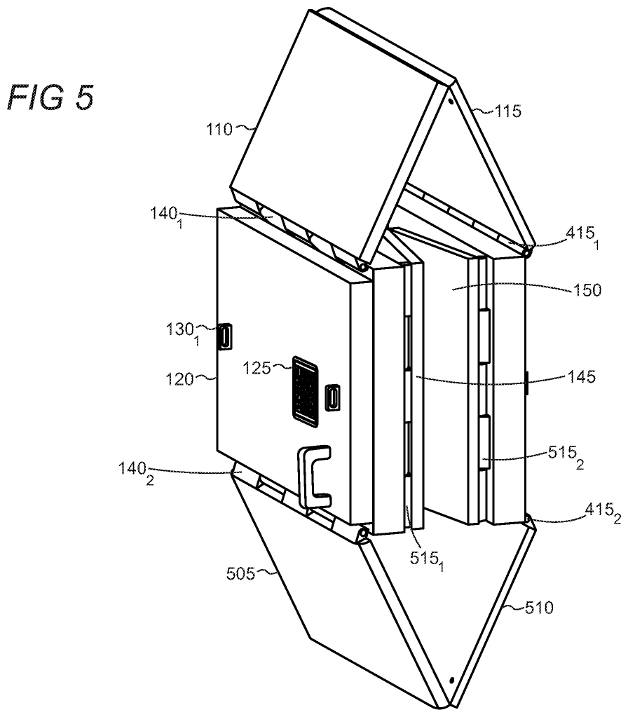

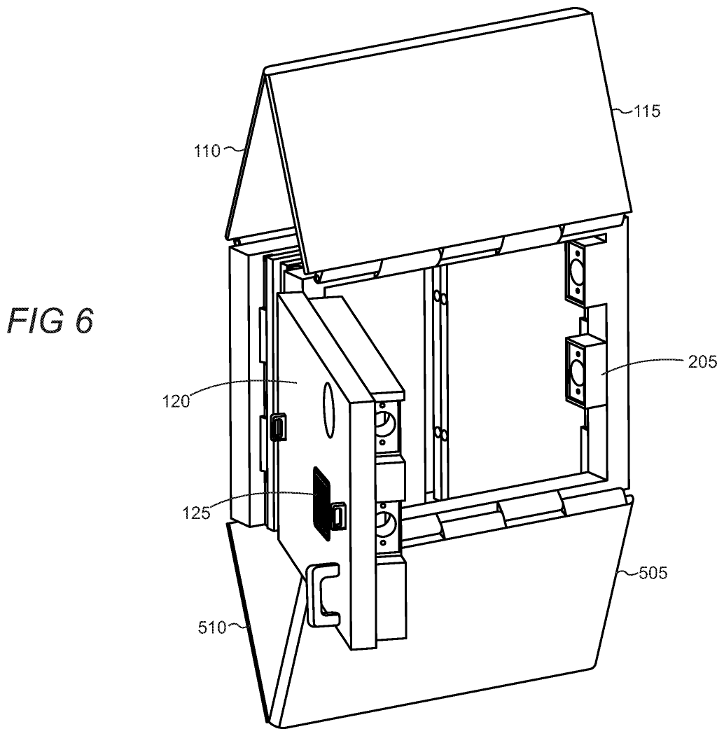

FIGS. 5-7 show illustrative representations of the foldable storage container in a folded position for easier handling and transportation. Folding of the container may occur after the stoppers 225 (FIG. 2) are each disengaged from the locked position. For example, the hook may be lifted and rotated 180° upwards so that the stopper no longer prevents the panels, such as the side, top, or bottom panels, from being adjusted. As shown in FIG. 6, in typical implementations, the door of the container may be disengaged from the frame, unlocked, and in the open position in order for the container to fold. FIG. 6 shows an exemplary implementation in which a dual deadbolt is implemented for enhanced security, but otherwise, operates the same as the other drawings.

As shown in FIG. 5, the front and rear top panels 110, 115 advance upward about their respective hinges 140, 415. Likewise, the front and rear bottom panels 505, 510 advance downward about the respective hinges 140, 415. Furthermore, the front and rear right side panels 145, 150 advance inward toward the container's cavity (FIG. 2) by rotating about the respective hinges 515. The front and rear left side panels 215, 220 may likewise push inward about their hinges, although not shown.

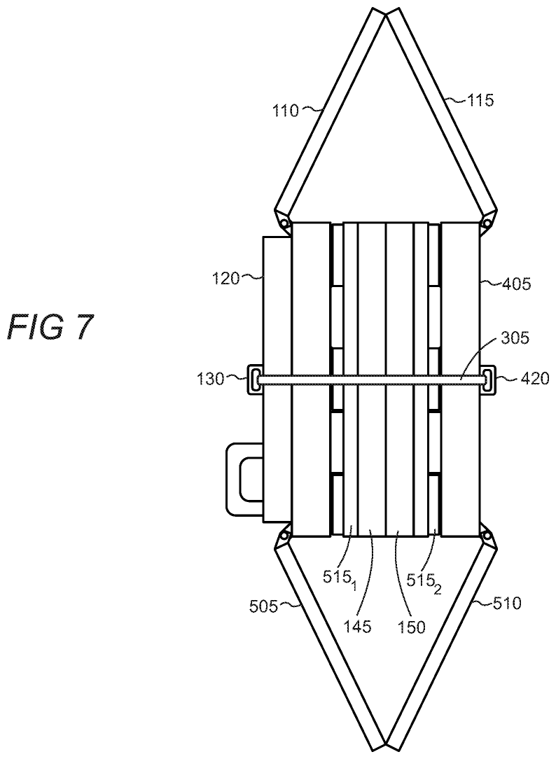

Upon the foldable storage container 105 being fully folded and compressed, a user can shut and lock the door 120 as shown in FIG. 7, to create a fully compact container for handling and transportation. When the container is fully folded, the straps 305 may extend through the front and rear strap mounts 130, 420 to maintain the container's folded state. A second strap may be utilized on the reverse side.

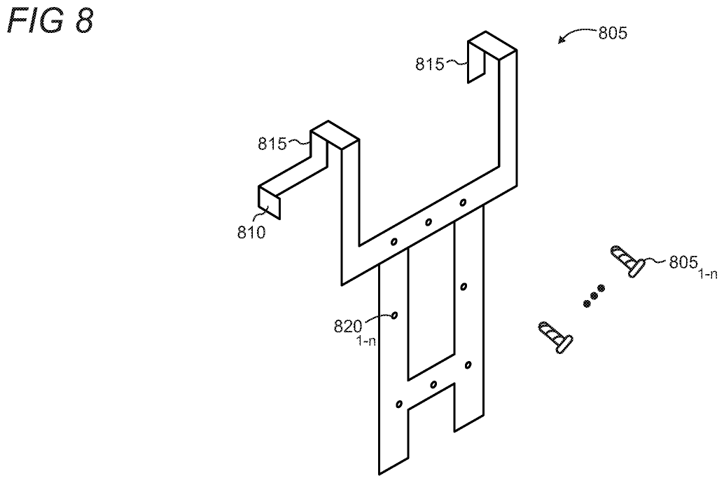

FIG. 8 shows an illustrative representation in which a hanging bracket 805 may be utilized with the foldable storage container 105. The hanging bracket has holes 820 which align with the rear panel holes 410 on the rear panel 420 (FIG. 4). One or more screws 805 and nuts (not shown) may be utilized to secure the hanging bracket to the container. Door mounts 815 on the hanging bracket are configured to enable the user to hang the container to, for example, a door, such as their front door. The extension 810 may provide additional support to the hanging bracket and container to accommodate the weight of the container itself and the packages stored therein. In addition to providing support, the extension 810 serves as a security point. When the extension is inserted between the door and the door frame, it works together with the door mount 815 to thereby prevent the box from being removed by an outsider. That is, the extension increases the difficulty for the bracket, and thereby the container, from being removed taken from the door.

Various exemplary embodiments of the foldable storage container is disclosed herein. One exemplary embodiment includes a foldable storage container, comprising: a frame having a receptacle to receive a deadbolt and a door hinge to which a door is attached and about which the door rotates to open and close the foldable storage container; an input mechanism on the door which receives user input and which causes the deadbolt to lock and unlock the door from the frame; and front panel hinges distinct from the door hinge and which are positioned on a top, bottom, right, and left sides of the frame, in which each front panel hinge is attached to a distinct panel that rotates about a respective front panel hinge, wherein rotation about respective front panel hinges causes the foldable storage container to adjust between a compressed state for easier handling and transportation and a boxed state for receiving packages.

As another example, the distinct panels attached to the front panel hinges include a front top panel, front bottom panel, front right panel, and front left panel, and further comprising a rear panel having rear panel hinges positioned on its top, bottom, right, and left sides which are respectively attached to a rear top panel, rear bottom panel, rear right panel, and rear left panel, each of which rotate about respective a rear panel hinge to cause the foldable storage container to adjust between the compressed state and the boxed state. In another example, the foldable storage container further comprising strap mounts positioned on the door and the rear panel. Another example further includes a strap which simultaneously buckles to the strap mounts on the door and rear panel when the foldable storage container is in the compressed state, such that the strap extends along a side of the foldable storage container and helps maintain its compressed state. As another example, the front top panel and rear top panel rotate upwards, about their respective front and rear panel hinges, away from an inside cavity of the foldable storage container. As another example, the front bottom panel and rear bottom panel rotate downwards, about their respective front and rear panel hinges, away from an inside cavity of the foldable storage container. As another example, the front right panel and rear right panel rotate inward, about their respective front and rear panel hinges, toward the inside cavity of the foldable storage container. As another example, the front left panel and rear left panel rotate inward, about their respective front and rear panel hinges, toward the inside cavity of the foldable storage container. Another example further includes a stopper positioned inside the foldable storage container's cavity and which prevents a panel from collapsing unintentionally. Another example further includes a latch to which the stopper engages and disengages. Another example further includes a hanging bracket to which a rear panel of the foldable storage container attaches, wherein the hanging bracket includes door mounts which enable the hanging bracket to hang on an object. As another example, the object on which the hanging bracket hangs is a door. In another example, the hanging bracket further includes an extension from a door mount to provide greater support to the hanging bracket and foldable storage container.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A foldable storage container, comprising:
a frame having a receptacle to receive a deadbolt and a door hinge to which a door is attached and about which the door rotates to open and close the foldable storage container;
an input mechanism on the door which receives user input and which causes the deadbolt to lock and unlock the door from the frame; and
front panel hinges distinct from the door hinge and which are positioned on a top, bottom, right, and left sides of the frame, in which each front panel hinge is attached to a distinct panel that rotates about a respective front panel hinge, wherein rotation about respective front panel hinges causes the foldable storage container to adjust between a compressed state for easier handling and transportation and a boxed state for receiving packages.

2. The foldable storage container of claim 1, wherein the distinct panels attached to the front panel hinges include a front top panel, front bottom panel, front right panel, and front left panel, and further comprising a rear panel having rear panel hinges positioned on its top, bottom, right, and left sides which are respectively attached to a rear top panel, rear bottom panel, rear right panel, and rear left panel, each of which rotate about respective a rear panel hinge to cause the foldable storage container to adjust between the compressed state and the boxed state.

3. The foldable storage container of claim 1, further comprising strap mounts positioned on the door and the rear panel.

4. The foldable storage container of claim 3, further comprising a strap which simultaneously buckles to the strap mounts on the door and rear panel when the foldable storage container is in the compressed state, such that the strap extends along a side of the foldable storage container and helps maintain its compressed state.

5. The foldable storage container of claim 2, wherein the front top panel and rear top panel rotate upwards, about their respective front and rear panel hinges, away from an inside cavity of the foldable storage container.

6. The foldable storage container of claim 5, wherein the front bottom panel and rear bottom panel rotate downwards, about their respective front and rear panel hinges, away from an inside cavity of the foldable storage container.

7. The foldable storage container of claim 6, wherein the front right panel and rear right panel rotate inward, about their respective front and rear panel hinges, toward the inside cavity of the foldable storage container.

8. The foldable storage container of claim 7, wherein the front left panel and rear left panel rotate inward, about their respective front and rear panel hinges, toward the inside cavity of the foldable storage container.

9. The foldable storage container of claim 1, further comprising a stopper positioned inside the foldable storage container's cavity and which prevents a panel from collapsing unintentionally.

10. The foldable storage container of claim 9, further comprising a latch to which the stopper engages and disengages.

11. The foldable storage container of claim 1, further comprising a hanging bracket to which a rear panel of the foldable storage container attaches, wherein the hanging bracket includes door mounts which enable the hanging bracket to hang on an object.

12. The foldable storage container of claim 11, wherein the object on which the hanging bracket hangs is a door.

13. The foldable storage container of claim 12, wherein the hanging bracket further includes an extension from a door mount to provide greater support to the hanging bracket and foldable storage container.
